(19) United States
(12) Patent Application Publication
(10) Pub. No.: US 2023/0147709 A1
(43) Pub. Date: May 11, 2023

(54) DRY AND COLD PERFORMANCE OF POLYAMIDES VIA INCORPORATION OF POLYETHER DIAMINES

(71) Applicant: Ascend Performance Materials Operations LLC, Houston, TX (US)

(72) Inventors: Jacob G. Ray, Houston, TX (US); Ramesh Ramakrishnan, Houston, TX (US)

(73) Assignee: Ascend Performance Materials Operations LLC, Houston, TX (US)

(21) Appl. No.: 17/984,681

(22) Filed: Nov. 10, 2022

Related U.S. Application Data
(60) Provisional application No. 63/277,831, filed on Nov. 10, 2021.
(60) Provisional application No. 63/340,288, filed on May 10, 2022.

(51) Int. Cl. C08L 77/06

(52) U.S. Cl. CPC C08L 77/06; C08L 2205/035; C08L 2205/025

(57) ABSTRACT

A polyamide composition comprising a base polyamide and an elastomer concentrate comprising: 20-80 wt % of an elastomeric aliphatic polyether having a molecular weight ranging from 400-4000 g/mol; and 80-20 wt % of a concentrate polyamide. The polyamide composition has particular uses as a cable tie and demonstrates improved cold-temperature applications while maintaining high strength, good flammability rating, and excellent processability.

### CROSS-REFERENCE TO RELATED APPLICATIONS

This application claims benefit of priority to U.S. Provisional Application No. 63/277,831, filed Nov. 10, 2021; and U.S. Provisional Application No. 63/340,288 filed May 10, 2022, both of which are herein incorporated by reference in their entirety.

### FIELD

The present disclosure relates to improvements in polyamides, particularly cable ties, for cold and dry installation performance.

### BACKGROUND

Conventional polyamides are generally known for use in many applications, including cable ties. In some of these applications, the polyamides in question may be exposed to low temperatures, e.g., −40° C. or lower. It is known that, when exposed to such low temperatures, a number of irreversible chemical and physical changes affect the polyamide, which manifest themselves through several disadvantageous properties. The polyamide may, for example, become brittle, leading to breakage problems.

Even for cable ties that are designed for colder temperatures, many experience failure rates of 10% or higher at cold temperatures. For example, conventional nylon cable ties demonstrate cold temperature failure rates around 15-20%.

Many of these conventional nylons, e.g., nylon 6,6, however, are known to offer desirable advantages, such as high tensile strength, desirable high flammability ratings, and low injection pressure/high flowability, and fast cycle times (i.e., <12 seconds). Traditional strategies of toughening these convention nylons, such as impact modification with maleated polyethylene materials, can provide desired cold and dry performance, but negatively affects flammability and strength properties.

There is therefore a need in the art for a polyamide composition that maintains the high strength and other beneficial properties associated with conventional nylons while providing improved dry and cold performance properties. This disclosure addresses that need.

### SUMMARY

In some embodiments, the disclosure relates to a polyamide composition comprising a base polyamide (e.g. a polyamide 6,6 homopolymer), and an elastomer concentrate comprising 20-80 wt % of an elastomeric aliphatic polyether (e.g. a polytetramethylether diamine or a polyethylene oxide diamine) having a molecular weight ranging from 400-4000 g/mol; and 80-20 wt % of a concentrate polyamide (e.g. PA66/610 or PA66/6).

In other embodiments, the disclosure relates to an article for use in cold-temperature applications (e.g. a cable tie) that is formed from a polyamide composition comprising a base polyamide (e.g. a polyamide 6,6 homopolymer), and an elastomer concentrate comprising: 20-80 wt % of an elastomeric aliphatic polyether (e.g. a polytetramethylether diamine or a polyethylene oxide diamine) having a molecular weight ranging from 400-4000 g/mol; and 80-20 wt % of a concentrate polyamide (e.g. PA66/610 or PA66/6).

In other embodiments, the disclosure relates to a process for improving dry- and cold-temperature performance in a polyamide composition, comprising the step of adding to a base polymer (e.g. a polyamide 6,6 homopolymer), an elastomer concentrate comprising: 20-80 wt % of an elastomeric aliphatic polyether (e.g. a polytetramethylether diamine or a polyethylene oxide diamine) having a molecular weight ranging from 400-4000 g/mol, and 80-20 wt % of a concentrate polyamide (e.g. PA66/610 or PA66/6). The process produces a modified polyamide composition having improved dry- and cold-temperature performance.

In other embodiments, the disclosure relates to In some embodiments, the disclosure relates to an elastomer concentrate comprising 20-80 wt % of an elastomeric aliphatic polyether (e.g. a polytetramethylether diamine or a polyethylene oxide diamine) having a molecular weight ranging from 400-4000 g/mol; and 80-20 wt % of a concentrate polyamide (e.g. PA66/610 or PA66/6).

### DETAILED DESCRIPTION

As noted above, conventional polyamide compositions, while demonstrating some desirable properties, suffer from drawbacks, e.g., poor cold temperature performance.

This disclosure relates to polyamide compositions comprising a base polyamide and an elastomer concentrate that provide for significant improvements in performance, particularly when used in articles for cold-temperature applications, such as cable ties. For instance, when the polyamide composition is formed as a cable tie, it demonstrates cable-tie-installation-performance failure rate, when measured in cold temperatures, of less than 15% or even less than 10%.

It has now been discovered that the utilization of an elastomer concentrate (along with a base polymer) has shown to improve dry and cold performance properties, while synergistically maintaining the high strength performance properties of known polyamides, e.g., PA6,6. Without being bound by theory, it is postulated that the elastomeric copolymer acts as a molecular level energy dampener, hence providing improved dry toughness and maintaining a mobile phase (low glass transition) phase at cold temperatures (i.e., <0-−40° C.). As a result, the disclosed polymer compositions provide for an unexpected combination of performance features, e.g., cold temperature failure rate, tensile strength, and V-2 flammability rating, that have not been previously achieved.

### Polyamide Composition

The disclosed polyamide compositions comprise a base polyamide (a first polyamide) and an elastomer concentrate that includes a concentrate polyamide (a second polyamide). Additional polyamides may also be included in the polyamide composition.

### Base Polyamide

The first polyamide may include varieties of natural and artificial polyamides. Common polyamides include nylons and aramids. For example, the first polyamide can include aliphatic polyamides such as polymeric E-caprolactam (PA6) and polyhexamethylene adipamide (PA66) or other aliphatic nylons, including polyamides with aliphatic and/or aromatic components. As used herein, the terms “PA6 polymer” and “PA6 polyamide polymer” also include copolymers in which PA6 is the major component. As used herein the terms “PA66 polymer” and “PA66 polyamide polymer” also include copolymers in which PA66 is the major component. In some cases, physical blends, e.g., melt blends, of these polymers are contemplated. In one embodiment, the polyamide polymer comprises PA6,6; PA6; PA610; PA611; PA612; PA10; PA11; PA12, or a combination thereof. Illustrative copolymers of these polyamides include PA6,6/6; PA6,6/610; PA6,6/611; PA6,6/612; PA6,6/10; PA6,6/11; PA6,6/12; PA6/6,6; PA6/610; PA6/611; PA6/612; PA6/10; PA6/11; and PA6/12.

As used herein, the terms “PA66,” “nylon 66,” and “polyamide 66” refer to a homopolymer prepared from hexamethylene diamine and adipic acid monomer subunits. A PA66 polyamide may be a polyamide that contains a significant portion of PA66 units in the polymer backbone, e.g., at least 5 wt %, at least 10 wt %, at least 20 wt %, at least 30 wt %, at least 40 wt %, at least 50 wt %, at least 60 wt %, at least 70 wt %, at least 8-0 wt % or at least 90 wt. As used herein, the terms “PA6,” “nylon 6,” and “polyamide 6” refer to a homopolymer prepared from caprolactam monomer subunits. As used herein, the terms “PA66/6,” “nylon 66/6,” and “polyamide 66/6” refer to a copolymer prepared from hexamethylene diamine and adipic acid monomer subunits and also incorporating caprolactam monomer subunits.

The first polyamide may be a copolymer or a homopolymer. For example, the first polyamide may be copolymer of PA6 and PA6,6, a PA6 homopolymer or a PA6,6 homopolymer.

Similarly, the second polyamide, also referred to as the concentrate polyamide, may include varieties of natural and artificial polyamides, such as that disclosed above for the first polyamide. Also, like the first polyamide, the second polyamide may be a copolymer or a homopolymer.

In one embodiment, the first polyamide, or the base polyamide, is a homopolymer, and the second polyamide, or the concentrate polyamide, is a polyamide copolymer. For example, the first polyamide is a PA6,6 homopolymer, and the second polyamide is a PA6,6/6 copolymer or a PA6,6/610 copolymer.

In some embodiments, the amount of the first polyamide, for instance the PA6,6 homopolymer, is present in the polyamide composition at ranges from 50 wt % to 99 wt %, e.g., from 50 wt % to 95 wt %, from 50 wt % to 90 wt %, from 60 wt % to 99 wt %, from 60 wt % to 95 wt %, from 75 wt % to 99 wt %, from 75 wt % to 95 wt %, from 80 wt % to 99 wt %, from 80 wt % to 95 wt %, or from 85 wt % to 95 wt %. In terms of upper limits, the first polyamide can be present in amounts less than 99 wt %, e.g., less than 95 wt %, or less than 90 wt %. In terms of lower limits, the first polyamide can be present in amounts greater than 50 wt %, e.g., greater than 60 wt %, greater than 70 wt %, greater than 80 wt %, greater than 90 wt %, greater than 95 wt %, or greater than 99 wt %.

The polyamides in the polyamide composition may comprise a combination of polyamides. By combining various polyamides, the final composition may be able to incorporate the desirable properties, e.g., mechanical properties, of each constituent polyamides.

In addition to the first and second polyamides, the polyamide composition may contain other polyamides which are the same or different from the first and second polyamides and can represent any of the polyamides noted above with respect to the first polyamide.

### Elastomer Concentrate

The polyamide composition comprises an elastomer concentrate, which in some cases comprises 20-80 wt % of an elastomeric aliphatic polyether having a molecular weight ranging from 400-4000 g/mol; and 80-20 wt % of a concentrate polyamide (the second polyamide). As noted above, the inclusion of the elastomer concentrate has unexpectedly been found to provide for the aforementioned synergistic combinations of performance features.

The weight percentage of the elastomer concentrate may comprise from 20-80 wt % of the elastomeric aliphatic polyether and 80-20 wt % of the concentrate polyamide. For instance, the elastomer concentrate may comprise 40 wt % of the elastomeric aliphatic polyether and 60 wt % of the concentrate polyamide; e.g., 45 wt % of the elastomeric aliphatic polyether and 55 wt % of the concentrate polyamide; 50 wt % of the elastomeric aliphatic polyether and 50 wt % of the concentrate polyamide; 55 wt % of the elastomeric aliphatic polyether and 45 wt % of the concentrate polyamide; or 60 wt % of the elastomeric aliphatic polyether and 40 wt % of the concentrate polyamide.

With respect to the elastomeric aliphatic polyether, the elastomer concentrate may comprise, in terms of upper limits, less than 80 wt % elastomeric aliphatic polyether, e.g., less than 60 wt %, less than 55 wt %, less than 50 wt %, less than 45 wt %, or less than 40 wt %. In terms of lower limits, the elastomer concentrate may comprise greater than 20 wt % elastomeric aliphatic polyether, e.g., greater than 40 wt %, greater than 45 wt %, greater than 50 wt %, greater than 55 wt %, or greater than 60 wt %.

With respect to the concentrate polyamide, the elastomeric aliphatic polyether may comprise, in terms of upper limits, less than 80 wt % concentrate polyamide, e.g., less than 60 wt %, less than 55 wt %, less than 50 wt %, less than 45 wt %, or less than 40 wt %. In terms of lower limits, the elastomer concentrate may comprise greater than 20 wt % concentrate polyamide, e.g., greater than 40 wt %, greater than 45 wt %, greater than 50 wt %, greater than 55 wt %, or greater than 60 wt %.

In one embodiment, the elastomeric aliphatic polyether comprises a compound of Formula (I):

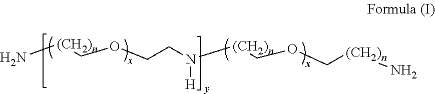

Each n can range from 1-5, e.g., from 1-4, from 1-3, from 2-5, from 2-4, or from 3-5. For instance, each n can be 1, 2, 3, 4, or 5. When n is 1, an ethylene oxide moiety may be present; when n is 3, a tetramethylether moiety may be present.

In some cases, each x ranges from 1-50. The larger the x value, the higher the molecular weight of the elastomeric aliphatic polymer becomes. Typically, the elastomeric aliphatic polyether has a molecular weight ranging from 400-4000 g/mol, for instance, from 500-2500 g/mol; from 500-2000 g/mol; from 500-1500 g/mol; from 1000-1500 g/mol; from 1500-2000 g/mol; from 1000-2000 g/mol; or from 1500-2500 g/mol.

In some cases, y ranges from 0-2. When y is 0, then the elastomeric aliphatic polyether is a diamine. When x is 1 or 2, then elastomeric aliphatic polyether is a triamine or a tetraamine, respectively.

In one embodiment, n is 1, x is 0, and the elastomeric aliphatic polyether has a molecular weight of 500-1500 g/mol. In this embodiment, the elastomeric aliphatic polyether is a polytetramethylether diamine.

In another embodiment, n is 3, x is 0, and the elastomeric aliphatic polyether has a molecular weight of 1500-2500 g/mol. In this embodiment, the elastomeric aliphatic polyether is a polyethylene oxide diamine.

In some cases, the concentrate may comprise the polyamides mentioned above with respect to the base polyamide. In some embodiments, the base polyamide and the concentrate polyamide differ from one another. In other embodiments, the base polyamide and the concentrate polyamide are the same polyamide.

In some embodiments, the concentrate polyamide, or the second polyamide unit, as noted above, can be a copolymer that comprises a combination of two of the following monomers: PA6,6; PA6; PA6,10; PA6,11; PA6,12; PA10; PA11; and PA12. Illustrative copolymers of these polyamides include PA6,6/6; PA6,6/6,10; PA6,6/6,11; PA6,6/6,12; PA6,6/10; PA6,6/11; PA6,6/12; PA6/6,6; PA6/6,10; PA6/6,11; PA6/6,12; PA6/10; PA6/11; and PA6/12.

When the second polyamide can combine with the elastomeric aliphatic polyether to form a terpolymer. For instance, when the second polyamide represents a PA66/610 copolymer, the elastomeric concentrate can be a PA66/610/elastomeric aliphatic polyether terpolymer. Alternatively, when the second polyamide represents a PA66/6 copolymer, the elastomeric concentrate can be a PA66/6/elastomeric aliphatic polyether terpolymer.

The elastomer concentrate can also be characterized as having repeat units of the elastomeric aliphatic polyether and the concentrate polyamide, including the components of the concentrate polyamide, namely adipic acid and hexamethylene diamine, for instance when the concentrate polyamide contains PA66. Even viewed in this perspective, the elastomer concentrate still comprises a copolymer/terpolymer comprising elastomer repeat units and polyamide repeat units comprising PA6,6; PA6; PA610; PA611, PA612; PA10; PA11; or PA12; or combinations thereof.

For instance, in one embodiment, the elastomer concentrate can be represented by Formula (II), in which the X component represents the elastomeric aliphatic polyether, and the Y component represents the concentrate polyamide. In this embodiment, the elastomeric aliphatic polyether is being represented as a polytetramethylether diamine.

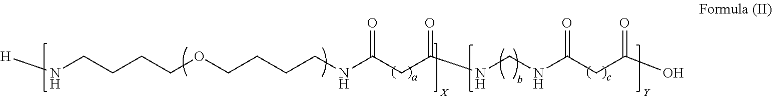

In Formula (II), a ranges from 2-16, b ranges from 4-12, and c ranges from 2-16. X represents 30-70 wt % of the polymer, and Y represents 30-70 wt % of the polymer.

The composition of Formula (II) can be further reacted with another polyamide, in the instance in which the concentrate polyamide represents a copolymer. Formulas (III) and (IV) represent embodiments in which the polyamide concentrate is a copolymer.

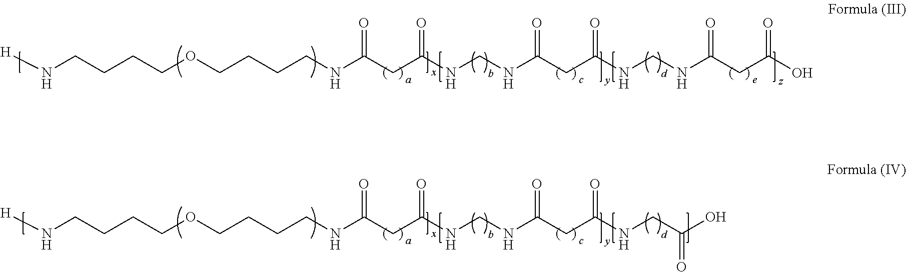

In Formula (III), a ranges from 2-16, b ranges from 4-12, c ranges from 2-16, d ranges from 4-12, and e ranges from 2-16. X represents 30-65 wt % of the polymer, and Y represents 30-65 wt % of the polymer, and Z represents 5-20 wt % of the polymer.

In Formula (IV), a ranges from 2-16, b ranges from 4-12, c ranges from 2-16, and d ranges from 4-11. X represents 30-60 wt % of the polymer, and Y represents 10-60 wt % of the polymer, and Z represents 10-60 wt % of the polymer.

Further examples of these structures can be shown when the elastomeric aliphatic polyether is being represented as a polyethylene oxide diamine. Similar to the above chemical structures, the X component represents the elastomeric aliphatic polyether, and the Y component represents the concentrate polyamide in Formula (V).

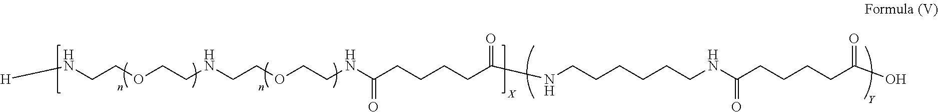

In Formula (V), each n ranges from 1-50; X represents 30-70 wt % of the polymer; and Y represents 30-70 wt % of the polymer.

The composition of Formula (V) can be further reacted with another polyamide, in the instance in which the concentrate polyamide represents a copolymer. Formula (VI) represents an embodiment in which the polyamide concentrate is a copolymer.

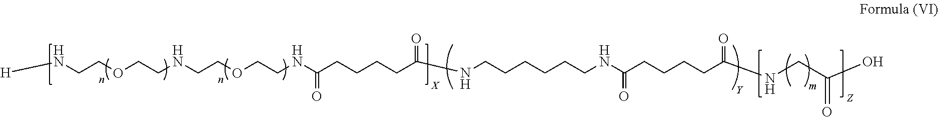

In Formula (VI), each n ranges from 1-50 and m ranges from 4-11. X represents 30-65 wt % of the polymer, Y represents 30-65 wt % of the polymer, and Z represents 5-20 wt % of the polymer.

The above structures, represented in Formulas II-VI, are illustrative examples of the elastomer concentrate when the elastomeric aliphatic polyether is being represented as either a polytetramethylether diamine or a polyethylene oxide diamine. Various other polymers, all falling within this disclosure, can be envisioned by one skilled in the art when other elastomeric aliphatic polyethers are used. Similarly, one skilled in the art can envision various other elastomer concentrate polymers, besides those illustrated in Formulas II-VI when other polyamide concentrates are used.

For instance, elastomer concentrates formed as block copolymers, more specifically polyamide-block-ether with ester linkages, are also contemplated. Formulas VII-VIII represent illustrative examples of these embodiments.

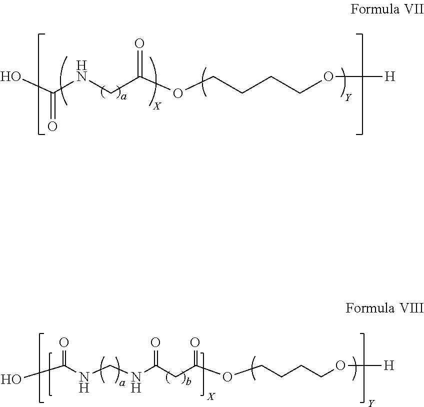

In Formula VII, a ranges from 4-12; X represents 30-70 wt % of the polymer; and Y represents 30-70 wt % of the polymer. In Formula VIII, a ranges from 4-12; b ranges from 2-16; X represents 30-70 wt % of the polymer; and Y represents 30-70 wt % of the polymer.

The overall weight percentages of the base polyamide an elastomer concentrate in the polyamide composition, based on the total amounts of base polyamide and elastomer concentrate, can vary widely. For instance, polyamide composition can comprise 1-25 wt % of the elastomer concentrate and 75-99 wt % of the base polyamide; 1-15 wt % of the elastomer concentrate and 85-99 wt % of the base polyamide; 1-10 wt % of the elastomer concentrate and 90-99 wt % of the base polyamide; 5-15 wt % of the elastomer concentrate and 85-95 wt % of the base polyamide; 5-20 wt % of the elastomer concentrate and 80-95 wt % of the base polyamide; or 5-10 wt % of the elastomer concentrate and 90-95 wt % of the base polyamide.

With respect to the base polyamide, the polyamide composition may comprise, in terms of upper limits, less than 99 wt % base polyamide, e.g., less than 95 wt %, less than 90 wt %, less than 85 wt %, less than 80 wt %, or less than 75 wt %. In terms of lower limits, the polyamide composition may comprise greater than 75 wt % base polyamide, e.g., greater than 80 wt %, greater than 85 wt %, greater than 90 wt %, greater than 95 wt %, or greater than 99 wt %.

With respect to the elastomer concentrate, the polyamide composition may comprise, in terms of upper limits, less than 25 wt % elastomer concentrate, e.g., less than 20 wt %, less than 15 wt %, less than 10 wt %, less than 5 wt %, or less than 1 wt %. In terms of lower limits, the polyamide composition may comprise greater than 1 wt % elastomer concentrate, e.g., greater than 5 wt %, greater than 10 wt %, greater than 15 wt %, greater than 20 wt %, or greater than 25 wt %.

Another embodiment relates to the elastomer concentrate, by itself. This embodiment is thus an elastomer concentrate comprising 20-80 wt % of an elastomeric aliphatic polyether having a molecular weight ranging from 400-4000 g/mol, and 80-20 wt % of a concentrate polyamide. The elastomeric aliphatic polyether, and concentrate polyamide in this embodiment relate to the same components described above.

When the elastomer concentrate is prepared by itself, it may be blended with a base polyamide using known preparation techniques. This can happen concurrently with the elastomer concentrate preparation, soon thereafter, or at a later point in time. It may be desirable, for instance, to prepare the elastomer concentrate in one location at one point in time, ship it to a second location to have a second party (e.g. customer) blend the elastomer concentrate with the base polyamide.

Alternatively, the polyamide elastomer may be used by itself in various applications for soft touch, flexible, tough materials. For instance, the polyamide elastomer could be an alternative to polyurethane elastomers, copolyester elastomers, or polyamide-block-ether elastomers.

### Heat Stabilizer Packages

The polyamide composition may include a heat stabilizer package, which can improve the utility and functionality of polyamide compositions by mitigating, retarding, or preventing the effects damage, e.g., thermooxidative damage, that result from exposure of polyamides to heat. The heat stabilizer packages may vary widely and include any of the polymer (polyamide) heat stabilizers are known and commercially available. Suitable heat stabilizers for use with the polyamide composition are disclosed in US Patent Application No. 2020/0247994, herein incorporated by reference in its entirety.

In some embodiments, the heat stabilizer package comprises a combination of heat stabilizers, e.g., first heat stabilizer and a second heat stabilizer.

The heat stabilizers may vary widely. Generally, the heat stabilizer may be a compound that comprises a lanthanoid, e.g., cerium or lanthanum. In some embodiments, the lanthanoid may be lanthanum, cerium, praseodymium, neodymium, promethium, samarium, europium, gadolinium, terbium, dysprosium, holmium, erbium, thulium, ytterbium, or lutetium, or combinations thereof. In some cases, the lanthanoids-based heat stabilizer may have has an oxidation number of +III or +IV.

In some cases, the heat stabilizer is generally of the structure (L)Xₙ, where X is a ligand and n is a non-zero integer, and L is the lanthanoid. That is to say, in some embodiments, the lanthanoid-based heat stabilizer is a lanthanoid-based ligand. The inventors have found that particular lanthanoid ligands are able to stabilize polyamides particularly well, especially when utilized in the aforementioned amounts, limits, and/or ratios. In some embodiments, the ligand(s) may be selected from the group consisting of acetates, hydrates, oxyhydrates, phosphates, bromides, chlorides, oxides, nitrides, borides, carbides, carbonates, ammonium nitrates, fluorides, nitrates, polyols, amines, phenolics, hydroxides, oxalates, oxyhalides, chromoates, sulfates, or aluminates, perchlorates, the monochalcogenides of sulphur, selenium and tellurium, carbonates, hydroxides, oxides, trifluoromethanesulphonates, acetylacetonates, alcoholates, 2-ethylhexanoates, or combinations thereof. Hydrates of these are contemplated as well.

In some cases, the ligand may be an oxide and/or an oxyhydrate. In some embodiments, the heat stabilizer comprises specific oxide/oxyhydrate compounds, preferably lanthanoid (cerium) oxide and/or lanthanoid (cerium) oxyhydrate.

In some embodiments, the polyamide composition comprises the lanthanoid-based compound, e.g., cerium/lanthanum oxide and/or cerium/lanthanum oxyhydrate, in an amount ranging from 0.01 wt % to 10.0 wt %, e.g., from 0.01 wt % to 8.0 wt %, from 0.01 wt % to 7.0 wt %, from 0.02 wt % to 5.0 wt %, from 0.03 to 4.5 wt %, from 0.05 wt % to 4.5 wt %, from 0.07 wt % to 4.0 wt %, from 0.07 wt % to 3.0 wt %, from 0.1 wt % to 3.0 wt %, from 0.1 wt % to 2.0 wt %, from 0.2 wt % to 1.5 wt %, from 0.1 wt % to 1.0 wt %, or from 0.3 wt % to 1.2 wt %. In terms of lower limits, the polyamide composition may comprise greater than 0.01 wt % heat stabilizer, e.g., greater than 0.02 wt %, greater than 0.03 wt %, greater than 0.05 wt %, greater than 0.07 wt %, greater than 0.1 wt %, greater than 0.2 wt %, or greater than 0.3 wt %. In terms of upper limits, the polyamide composition may comprise less than 10.0 wt % heat stabilizer, e.g., less than 8.0 wt %, less than 7.0 wt %, less than 5.0 wt %, less than 4.5 wt %, less than 4.0 wt %, less than 3.0 wt %, less than 2.0 wt %, less than 1.5 wt %, less than 1.2 wt %, less than 1.0 wt %, or less than 0.7 wt %.

In some embodiments, the polyamide composition comprises less than 1.0 wt % of cerium dioxide, e.g., less than 0.7 wt %, less than 0.5 wt %, less than 0.3 wt %, less than 0.1 wt %, less than 0.05 wt %, or less than 0.01 wt %. In terms of ranges, the polyamide composition may comprise from 1 wppm to 1 wt % of cerium dioxide, e.g., from 1 wppm to 0.5 wt %, from 1 wppm to 0.1 wt %, from 5 wppm to 0.05 wt %, or from 5 wppm to 0.01 wt %.

In some cases, the polyamide composition comprises little or no cerium hydrate, e.g., less than 10.0 wt % cerium hydrate, e.g., less than 8.0 wt %, less than 7.0 wt %, less than 5.0 wt %, less than 4.5 wt %, less than 4.0 wt %, less than 3.0 wt %, less than 2.0 wt %, less than 1.5 wt %, less than 1.2 wt %, less than 1.0 wt %, less than 0.7 wt %, less than 0.5 wt %, less than 0.3 wt %, or less than 0.1 wt %. In some cases, the polyamide composition comprises substantially no cerium hydrate, e.g., no cerium hydrate.

In some embodiments, the heat stabilizer may be selected from the group consisting of phenolics, amines, polyols, and combinations thereof.

For example, the heat stabilizer package may comprise amine stabilizers, e.g., secondary aromatic amines. Examples include adducts of phenylene diamine with acetone (Naugard A), adducts of phenylene diamine with linolene, Naugard 445, N,N′-dinaphthyl-p-phenylene diamine, N-phenyl-N′-cyclohexyl-p-phenylene diamine, N,N′-diphenyl-p-phenylene diamine or mixtures of two or more thereof.

Other examples include heat stabilizers based on sterically hindered phenols. Examples include N,N′-hexamethylene-bis-3-(3,5-di-tert-butyl-4-hydroxyphenyl)-propionamide, bis-(3,3-bis-(4′-hydroxy-3′-tert-butylphenyl)-butanoic acid)-glycol ester, 2,1′-thioethylbis-(3-(3,5-di-tert-butyl-4-hydroxyphenyl)-propionate, 4-4′-butylidene-bis-(3-methyl-6-tert-butylphenol), triethyleneglycol-3-(3-tert-butyl-4-hydroxy-5-methylphenyl)-propionate or mixtures these stabilisers.

Further examples include phosphites and/or phosphonites. Specific examples include phosphites and phosphonites are triphenylphosphite, diphenylalkylphosphite, phenyldialkylphosphite, tris(nonylphenyl)phosphite, trilaurylphosphite, trioctadecylphosphite, distearylpentaerythritoldiphosphite, tris(2,4-di-tert-butylphenyl)phosphite, diisodecylpentaerythritoldiphosphite, bis(2,4-di-tert-butylphenyl) pentaerythritoldiphosphite, bis(2,6-di-tert-butyl-4-methylphenyl)pentaerythritoldiphosphite, diisodecyloxypentaerythritoldiphosphite, bis(2,4-di-tert-butyl-6-methylphenyl)pentaerythritoldiphosphite, bis(2,4,6-tris-(tert-butylphenyl)pentaerythritoldiphosphite, tristearylsorbitoltriphosphite, tetrakis(2,4-di-tert-butylphenyl)-4,4′-biphenylenediphosphonite, 6-isooctyloxy-2,4,8,10-tetra-tert-butyl-12H-dibenzo[d,g]-1,3,2-dioxaphosphocine, 6-fluoro-2,4,8,10-tetra-tert-butyl-12-methyl-dibenzo[d,g]-1,3,2-dioxaphosphocine, bis(2,4-di-tert-butyl-6-methylphenyl)methylphosphite and bis(2,4-di-tert-butyl-6-methylphenyl)ethylphosphite. Particularly preferred are tris[2-tert-butyl-4-thio(2′-methyl-4′-hydroxy-5′-tert-butyl)-phenyl-5-methyl]phenylphosphite and tris(2,4-di-tert-butylphenyl)phosphite (Hostanox® PAR24: commercial product of the company Clariant, Basel).

In some embodiments, the heat stabilizer comprises a copper-based stabilizer. By way of non-limiting example, the copper-based compound may comprise compounds of mono- or bivalent copper, such as salts of mono- or bivalent copper with inorganic or organic acids or with mono- or bivalent phenols, the oxides of mono- or bivalent copper, or complex compounds of copper salts with ammonia, amines, amides, lactams, cyanides or phosphines, and combinations thereof. In some preferred embodiments, the copper-based compound may comprise salts of mono- or bivalent copper with hydrohalogen acids, hydrocyanic acids, or aliphatic carboxylic acids, such as copper(I) chloride, copper(I) bromide, copper(I) iodide, copper(I) cyanide, copper(II) oxide, copper(II) chloride, copper(II) sulfate, copper(II) acetate, or copper (II) phosphate. Preferably, the copper-based compound is copper iodide and/or copper bromide. The copper heat stabilizer may be employed with a halide additive discussed below. Copper stearate, as a heat stabilizer (not as a stearate additive) is also contemplated.

In some embodiments, the polyamide composition comprises the copper heat stabilizer in an amount ranging from 0.01 wt % to 5.0 wt %, e.g., from 0.01 wt % to 4.0 wt %, from 0.02 wt % to 3.0 wt %, from 0.03 to 2.0 wt %, from 0.03 wt % to 1.0 wt %, from 0.04 wt % to 1.0 wt %, from 0.05 wt % to 0.5 wt %, from 0.05 wt % to 0.2 wt %, or from 0.07 wt % to 0.1 wt %. In terms of lower limits, the polyamide composition may comprise greater than 0.01 wt % copper heat stabilizer, e.g., greater than 0.02 wt %, greater than 0.03 wt %, greater than 0.035 wt %, greater than 0.04 wt %, greater than 0.05 wt %, greater than 0.07 wt %, or greater than 0.1 wt %. In terms of upper limits, the polyamide composition may comprise less than 5.0 wt % copper heat stabilizer, e.g., less than 4.0 wt %, less than 3.0 wt %, less than 2.0 wt %, less than 1.0 wt %, less than 0.5 wt %, less than 0.2 wt %, less than 0.1 wt %, less than 0.05 wt %, or less than 0.035 wt %.

In some embodiments, polyamide composition comprises the copper heat stabilizer, e.g., copper-based compound, in an amount ranging from 1 ppm to 1500 ppm, e.g., from 10 ppm to 1200 ppm, from 50 ppm to 1000 ppm, from 50 ppm to 800 ppm, from 100 ppm to 750 ppm, from 200 ppm to 700 ppm, from 300 ppm to 600 ppm, or from 350 ppm to 550 ppm. In terms of lower limits, the polyamide composition comprises the copper heat stabilizer in an amount greater than 1 ppm, e.g., greater than 10 ppm, greater than 50 ppm, greater than 100 ppm, greater than 200 ppm, greater than 300 ppm, or greater than 350 ppm. In terms of upper limits, the polyamide composition comprises the copper stabilizer in an amount less than 1500 ppm, e.g., less than 1200 ppm, less than 1000 ppm, less than 800 ppm, less than 750 ppm, less than 700 ppm, less than 600 ppm, or less than 550 ppm.

The polyamide may further comprise (in addition to the heat stabilizers) a halide additive, e.g., a chloride, a bromide, and/or an iodide. In some cases, the purpose of the halide additive is to improve the stabilization of the polyamide composition. Surprisingly, the inventors have discovered that, when employed as described herein, the halide additive works synergistically with the stabilizer package by mitigating free radical oxidation of polyamides. Exemplary halide additives include potassium chloride, potassium bromide, and potassium iodide. In some cases, these additives are utilized in amounts discussed herein.

The halide additive may vary widely. In some cases, the halide additive may be utilized with the copper heat stabilizer. In some cases, the halide additive is not the same component as the copper heat stabilizer, e.g., the copper heat stabilizer, copper halide, is not considered a halide additive. Halide additive are generally known and are commercially available. Exemplary halide additives include iodides and bromides. Preferably, the halide additive comprises a chloride, an iodide, and/or a bromide.

In some embodiments, the halide additive is present in the polyamide composition in an amount ranging from 0.001 wt % to 1 wt %, e.g., from 0.01 wt % to 0.75 wt %, from 0.01 wt % to 0.75 wt %, from 0.05 wt % to 0.75 wt %, from 0.05 wt % to 0.5 wt %, from 0.075 wt % to 0.75 wt %, or from 0.1 wt % to 0.5 wt %. In terms of upper limits, the halide additive may be present in an amount less than 1 wt %, e.g., less than 0.75 wt %, or less than 0.5 wt %. In terms of lower limits, the halide additive may be present in an amount greater than 0.001 wt %, e.g., greater than 0.01 wt %, greater than 0.05 wt %, greater than 0.075 wt %, or greater than 0.1 wt %.

In some embodiments, halide, e.g., iodide, is present in an amount ranging from 30 wppm to 5000 wppm, e.g., from 30 wppm to 3000 wppm, from 50 wppm to 2000 wppm, from 50 wppm to 1000 wppm, from 75 wppm to 750 wppm, from 100 wppm to 500 wppm, from 150 wppm to 450 wppm, or from 200 wppm to 400 wppm. In terms of lower limits, the halide may be present in an amount at least 30 wppm, e.g,. at least 50 wppm, at least 75 wppm, at least 100 wppm, at least 150 wppm, or at least 200 wppm. In terms of upper limits, the halide may be present in an amount less than 5000 wppm, e.g., less than 3500 wppm, less than 3000 wppm, less than 2000 wppm, less than 1000 wppm, less than 750 wppm, less than 500 wppm, less than 450 wppm, or less than 400 wppm. Total halide, e.g., iodide, content in some cases includes iodide from all sources, e.g., copper iodide, and additives, e.g., potassium iodide.

The heat-stabilized polyamide preferably may comprise the stearate additives, e.g., calcium stearates, but in small amounts, if any. Generally, stearates are not known to contribute to stabilization; rather, stearate additives are typically used for lubrication and/or to aid in mold release. Because synergistic small amounts are employed, the disclosed heat-stabilized polyamide compositions are able to effectively produce polyamide structures without requiring high amounts of stearate lubricants typically present in conventional polyamides, thus providing production efficiencies. Also, the inventors have found that the small amounts of stearate additive reduces the potential for formation of detrimental stearate degradation products. In particular, the stearate additives have been found to degrade at higher temperatures, giving rise to further stability problems in the polyamide compositions.

In some cases, the polyamide composition beneficially comprises little or no stearates, e.g., calcium stearate or zinc stearate. The stearate additive may be present in synergistic small amounts. For example, the polyamide composition may comprise less than 0.3 wt % stearate additive, e.g., less than 0.25 wt %, less than 0.2 wt %, less than 0.15 wt %, less than 0.10 wt %, less than 0.05 wt %, less than 0.03 wt %, less than 0.01 wt %, or less than 0.005 wt %. In terms of ranges, the polyamide composition may comprise from 1 wppm to 0.3 wt % stearate additive, e.g., from 1 wppm to 0.25 wt %, from 5 wppm to 0.1 wt %, from 5 wppm to 0.05 wt %, or from 10 wppm to 0.005 wt %. In terms of lower limits, the polyamide composition may comprise greater than 1 wppm stearate additive, e.g., greater than 5 wppm, greater 10 wppm, or greater than 25 wppm. In some embodiments, the polyamide composition comprises substantially no stearate additive, e.g., comprises no stearate additive.

In some cases, the polyamide composition comprises little or no antioxidant additives, e.g., phenolic antioxidants. As noted above, antioxidants are known polyamide stabilizers that are unnecessary in the polyamide compositions of the present disclosure. Preferably, the polyamide composition comprises no antioxidants. As a result, there is advantageously little need for antioxidant additives, and production efficiencies are achieved. For example, the polyamide composition may comprise less than 5 wt % antioxidant additive, e.g., less than 4.5 wt %, less than 4.0 wt %, less than 3.5 wt %, less than 3.0 wt %, less than 2.5 wt %, less than 2.0 wt %, less than 1.5 wt %, less than 1.0 wt %, less than 0.5 wt %, or less than 0.1 wt %. In terms of ranges, the polyamide composition may comprise from 0.0001 wt % to 5 wt % antioxidants, e.g., from 0.001 wt % to 4 wt %, from 0.01 wt % to 3 wt %, from 0.01 wt % to 2 wt %, from 0.01 wt % to 1 wt %, from 0.01 wt % to 0.5 wt %, or from 0.05 wt % to 0.5 wt %. In terms of lower limits, the polyamide composition may comprise greater than 0.0001 wt % antioxidant additive, e.g., greater than 0.001 wt %, greater than 0.01 wt %, greater than 0.05, or greater than 0.1 wt %.

### Lubricants

The polyamide composition may comprise one or more lubricants known to those of skill in the art to be compatible with polyamide compositions. Suitable lubricants include long-chain fatty acids (e.g., stearic acid or behenic acid), their salts (e.g., Ca stearate or Zn stearate) or their ester or amide derivatives (e.g., ethylenebisstearylamide), montan waxes (mixtures composed of straight-chain, saturated carboxylic acids having chain lengths of from 28 to 32 carbon atoms) or low-molecular-weight polyethylene waxes or low-molecular-weight polypropylene waxes. For example, the lubricant can be the salt of stearic acid, such as Al stearate, Zn stearate, or Ca stearate. In one embodiment, the lubricant includes one or more of ethylene bis(stearamdie) (EBS), stearyl erucamide, montan waxes, polyethylene waxes, and polypropylene waxes. The lubricant is typically present in amounts ranging from 0-5%, such as 0.1-5%, 0.1-4%, 0.1 to 3%, 1-5%, and 1-3%.

### Color Package

The polyamide composition may comprise a color package containing colorants known to those of skill in the art to be compatible with polyamide compositions. Suitable components in the color package include colorants, carbon black, nigrosine, and combinations thereof. Colorants that may be used with the polyamide composition are disclosed in US Patent Application No. 2021/0277203, herein incorporated by reference in its entirety.

The concentration of the nigrosine in the polyamide composition can, for example, range from 0 to 5 wt %, e.g., from 0.1 wt % to 1 wt %, from 0.15 wt % to 1.5 wt %, from 0.22 wt % to 2.3 wt %, from 0.32 wt % to 3.4 wt %, or from 0.48 wt % to 5 wt %. In some embodiments, the concentration of the nigrosine ranges from 1 wt % to 2 wt %, e.g., from 1 wt % to 1.6 wt %, from 1.1 wt % to 1.7 wt %, from 1.2 wt % to 1.8 wt %, from 1.3 wt % to 1.9 wt %, or from 1.4 wt % to 2 wt %. In terms of upper limits, the nigrosine concentration can be less than 5 wt %, e.g., less than 3.4 wt %, less than 2.3 wt %, less than 2 wt %, less than 1.9 wt %, less than 1.8 wt %, less than 1.7 wt %, less than 1.6 wt %, less than 1.5 wt %, less than 1.4 wt %, less than 1.3 wt %, less than 1.2 wt %, less than 1.1 wt %, less than 1 wt %, less than 0.71 wt %, less than 0.48 wt %, less than 0.32 wt %, less than 0.22 wt %, or less than 0.15 wt %. In terms of lower limits, the nigrosine concentration can be greater than 0.1 wt %, e.g., greater than 0.15 wt %, greater than 0.22 wt %, greater than 0.32 wt %, greater than 0.48 wt %, greater than 0.71 wt %, greater than 1 wt %, greater than 1.1 wt %, greater than 1.2 wt %, greater than 1.3 wt %, greater than 1.4 wt %, greater than 1.5 wt %, greater than 1.6 wt %, greater than 1.7 wt %, greater than 1.8 wt %, greater than 1.9 wt %, greater than 2 wt %, greater than 2.3 wt %, or greater than 3.4 wt %. Lower concentrations, e.g., less than 0.1 wt %, and higher concentrations, e.g., greater than 5 wt %, are also contemplated. In some cases, the nigrosine is provided in a masterbatch, and the concentration of the nigrosine in the masterbatch and in the resultant composition can be easily calculated.

The concentration of the carbon black in the polyamide composition can, for example, range from 0 to 5 wt %, e.g., from 0.1 wt % to 1.05 wt %, from 0.15 wt % to 1.55 wt %, from 0.22 wt % to 2.29 wt %, from 0.32 wt % to 3.38 wt %, or from 0.48 wt % to 5 wt %. In some embodiments, the concentration of the carbon black ranges from 0.2 wt % to 0.8 wt %. In terms of upper limits, the carbon black concentration can be less than 5 wt %, e.g., less than 3.4 wt %, less than 2.3 wt %, less than 1.5 wt %, less than 1 wt %, less than 0.71 wt %, less than 0.48 wt %, less than 0.32 wt %, less than 0.22 wt %, or less than 0.15 wt %. In some embodiments, the concentration of the carbon black is less than 3 wt %. In terms of lower limits, the carbon black concentration can be greater than 0.1 wt %, e.g., greater than 0.15 wt %, greater than 0.22 wt %, greater than 0.32 wt %, greater than 0.48 wt %, greater than 0.71 wt %, greater than 1 wt %, greater than 1.5 wt %, greater than 2.3 wt %, or greater than 3.4 wt %. Lower concentrations, e.g., less than 0.1 wt %, and higher concentrations, e.g., greater than 5 wt %, are also contemplated.

### Nucleating Agents

The polyamide composition may comprise one or more nucleating agents known to those of skill in the art to be compatible with polyamide compositions. The nucleating agent is typically present, if at all, in small amounts, to further improve clarity and oxygen barrier as well as enhance oxygen barrier. Typically, these agents are insoluble, high melting point species that provide a surface for crystallite initiation. By incorporating a nucleating agent, more crystals are initiated, which are smaller in nature. More crystallites or higher % crystallinity correlates to more reinforcement/higher tensile strength and a more tortuous path for oxygen flux (increased barrier); smaller crystallites decreases light scattering which correlates to improved clarity. Suitable nucleating agents include calcium fluoride, calcium carbonate, talc, PA 2,2, and combinations thereof.

Beneficially, the polyamide compositions demonstrate suitable clarity and/or oxygen barrier properties, while not requiring greater amounts of nucleating agent. In some embodiments, the polyamide composition of any of the preceding claims, wherein the polyamide composition comprises less than 2.2 wt % nucleation agent, e.g., less than 2.0 wt %, less than 1.8 wt %, less than 1.5 wt %, less than 1.2 wt %, less than 1.0 wt %, less than 0.8 wt %, less than 0.5 wt %, less than 0.3 wt %, or less than 0.1 wt %.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

These components mentioned herein may be considered optional. In some cases, the disclosed compositions may expressly exclude one or more of the aforementioned components in this section, e.g., via claim language. For example claim language may be modified to recite that the disclosed compositions, processes, etc., do not utilize or comprise one or more of the aforementioned components, e.g., the compositions do not include carbon black.

### Molded Articles

The present disclosure also relates to articles that include the polyamide compositions. The article can be produced, for example, via conventional injection molding, extrusion molding, blow molding, press molding, compression molding, or gas assist molding techniques. Molding processes suitable for use with the disclosed compositions and articles are described in U.S. Pat. Nos. 8,658,757; 4,707,513; 7,858,172; and 8,192,664, each of which is incorporated herein by reference in its entirety for all purposes. Examples of articles that can be made with the provided polyamide compositions include those used in electrical and electronic applications (such as, but not limited to, circuit breakers, terminal blocks, connectors and the like), automotive applications (such as, but not limited to, air handling systems, radiator end tanks, fans, shrouds, and the like), furniture and appliance parts, and wire positioning devices such as cable ties.

A particular use for the polyamide compositions relates to their use in cold-temperature applications. Articles for use in cold-temperature applications include fasteners, circuit breakers, terminal blocks, connectors, automotive parts, furniture parts, appliance parts, cable ties, sports equipment, gun stocks, window thermal breaks, aerosol valves, food film packaging, automotive/vehicle parts, textiles, industrial fibers, carpeting, or electrical/electronic parts. Cable ties, such as cable ties for electrical installation, are particularly suitable for the disclosed polyamide compositions.

### Performance Characteristics

The aforementioned polyamide compositions demonstrate surprising performance results. For example, the polyamide compositions maintain tensile performance, molding cycle time (loop strength), and flammability retardation metrics that are equivalent to or better than known conventional polyamide compositions, such as PA6,6, while providing improved cold-weather installation performance (lower fail rates). These performance parameters are exemplary and the examples support other performance parameters that are contemplated by the disclosure.

### Tensile Strength

In one embodiment, the polyamide composition demonstrates a tensile strength of at least 50 MPa, e.g., at least 55 MPa, at least 60 MPa, at least 70 MPa, at least 80 MPa. In terms of ranges, the tensile strength may range from 50 MPa to 150 MPa, e.g., from 60 MPa to 125 MPa, from 70 MPa to 100 MPa, from 75 MPa to 95 MPa, or from 80 MPa to 95 MPa.

Generally, tensile strength measurements may be conducted under ISO 527-1 (2019), Charpy notched impact energy loss of the polyamide composition may be measured using a standard protocol such as ISO 179-1 (2010).

### Loop Strength

The loop strength measurement is an Instron based test where cable ties are fastened around a mandrel attachment, the mandrel attachment opens at a constant rate, and forces are measured in lb. The force required to break the cable tie is the metric that is reported. An acceptable ISO spec for the loop test is ISO 527. In some embodiments, the polyamide compositions demonstrate improved loop strength, measured at 23° C., of at least 70 lbf (pound force), e.g., at least 80 lbf, at least 90 lbf, or at least 95 lbf. In terms of range, the loop strength may range from 50-150 lbf, 60-125 lbf, 70-110 lbf, or 80-100 lbf.

### Injection Molding

Improved injection molding results show that the polyamide compositions of the invention can be processed at lower temperatures, providing better molecular weight retention, which will further improve performance properties, such as strength and toughness. Another advantage of low injection pressures or improved flow is that the lower processing temperatures and maintained higher molecular weight, in turn provides to better part toughness and in-use longevity.

### Molding Cycle Time

Molding cycle time is the time which it takes to go through one injection molding cycle. This process includes injecting molten polymer into a cavity, cooling the polymer, opening the mold, and ejecting parts. Polymer metrics that dictate the cycle time strongly are (1) injection pressure or flowability of the polymer, (2) how fast the polymer crystallizes, and (3) the surface lubricity that enables efficient part ejection.

### Flammability

In certain embodiments, the polyamide compositions demonstrate a V-2 flammability rating at various tested thicknesses. Under the UL94 standard, the following requirements need to be met to achieve a V-2 rating: (1) the specimens may not burn with flaming combustion for more than 30 seconds after either application of the test flame; (2) the total flaming combustion time may not exceed 250 seconds for the 10 flame applications for each set of 5 specimens; (3) the specimens may not burn with flaming or glowing combustion up to the holding clamp; (4) the specimens can drip flaming particles that ignite the dry absorbent surgical cotton located 300 mm below the test specimen; and (5) the specimens may not have glowing combustion that persists for more than 60 seconds after the second removal of the test flame.

Flammability testing was conducted on samples at various thicknesses (0.4, 0.75, 1.5, and 3.0 mm) according to the UL94 standard.

### Installation Test

In some embodiments, the polyamide compositions, formed as cable ties, demonstrate equivalent room-temperature installation performance and superior cold-weather installation performance, measured by failure rates.

The cable ties can be tested for performance using various techniques, such as those described by Underwriters Laboratory (UL) Standard No. 62275, which describes, for example, how to install a cable tie.

The cable ties were injection molded from the polyamide composition and sealed in moisture proof packaging to keep them “dry as molded.” The cable ties were then hand installed on a steel mandrel using an installation gun (installation tool) with an adjustable tensioning capability, calibrated to deliver approximately 35 to 37 lbs of tension during installation before cutting the excess “tail” off of the tie. Installation of the ties is considered successful if the assembled cable tie is installed without any breakage, and remains intact after installation. The installation test is therefore a pass-fail type of test, wherein the success rate (i.e., the percentage of ties passing the installation test) is a measure of the toughness of the polyamide composition. Installation can be performed at 23° C., 10-20% relative humidity (room temperature installation performance) and −40° C., 10-20% relative humidity (cold weather installation performance).

The polyamide compositions unexpectedly demonstrate a cold-weather cable-tie-installation-performance fail rate of under 20%, e.g., under 15%, under 10%, under 5%, and under 1%.

Embodiments of this invention thus relate to polyamide compositions, such as cable ties, having a tensile strength greater than 60 MPa, a flame rating of V-2 or higher, and/or a cold-weather cable-tie-installation-performance fail rate of under 20%, e.g., under 15%, under 10%, under 5%, and under 1%. This combination has not been possible with either impact-modified or standard PA66 molding grades.

Another embodiment relates to a process for improving cold-temperature performance in a polyamide composition. The process comprises the step of adding to a base polymer an elastomer concentrate comprising an elastomer concentrate to produce a modified polyamide composition having improved cold-temperature performance. The elastomer concentrate comprises 20-80 wt % of an elastomeric aliphatic polyether having a molecular weight ranging from 400-4000 g/mol, and 80-20 wt % of a concentrate polyamide.

The elastomer concentrate, elastomeric aliphatic polyether, and concentrate polyamide in this method relates the same components described above; the articles for using the polyamide composition, such as a cable tie, as the same as those described above; and improved properties for the polyamide compositions are the same as those described above.

### Examples

### Example 1—Polyether Diamine

The following polyamide compositions were prepared by polymerization in a 2 L autoclave through a high solids methodology (solids content>80 wt %). Table 1 reports the components of each example. In a beaker, diacids (adipic acid, and/or dodecanedioic acid) were weighed out. In a separate beaker 50% aqueous hexamethylene diamine (HMD) was prepared. Finally, in another beaker, polyether diamine (Elastamine® HT1100) was weighed out as shown in Table 1. An antioxidant (phenolic—NA281—Antioxidant 1076) and a sodium hypophosphite catalyst (NA047) were also added to the autoclave. The components were not mixed when added but layered in the following order: HMD, dodecanedioic acid or carpolactam, adipic acid, additives of antioxidant and catalyst, and polyether diamine. After getting desired weights of all components, materials were added to the autoclave bomb equipped with agitation and assembled to polymerization equipment equipped with nitrogen, pressurization, and electrical heating. Before stirring was initiated, the reaction mixture (>80 wt % solids) was heated to above 130° C. at slightly elevated pressures about 18.03 atm (265 psia); pre-heating before stirring/agitation allows for diacid and polyether diamine components to homogenize, and it was discovered that pre-stirring can lead to a bi-phasic system and unsuccessful polymerization. After temperatures exceeded 130° C., agitation was started with pressures at about 17.01 atm to about 18.71 atm (250-275 psia) and the reaction mixture was heated to a peak temperature of 230-250° C. over a period of 45 to 90 min. Subsequently, pressures were decreased over a period of 15 to 90 min while maintaining the target temperature between 240° C. and 260° C. The reaction was held at reduced pressures about 0.34 atm to about 0.68 atm (5-10 psia) for 30 to 240 min, depending on the desired molecular weight, followed by extrusion and pelletization employing nitrogen head pressure to push polymer out of the die orifice.

Table 1 reports the formulations for creating the polymers with different amounts of polyether diamine. Examples 1a, 1b, 1c and 1d comprised 40% polyether diamine, while examples 1e, 1f, 1g, and 1h comprised 50% polyether diamine. Table 1 reports molar amounts.

TABLE 1

| | 1a | 1b | 1c | 1d | 1e | 1f | 1g | 1h |
|---|---|---|---|---|---|---|---|---|
| Adipic Acid | 253.7 | 296 | 200.8 | 253.7 | 211.4 | 253.7 | 158.4 | 211.4 |
| Dodecanediodic Acid | — | — | 182.3 | 121.5 | — | — | 182.3 | 121.5 |
| Caprolactam | 164 | 98.4 | — | — | 165 | 98.4 | — | — |
| HMD (50% aq.) | 340.6 | 407.9 | 440.9 | 463.6 | 256.4 | 323.7 | 356.7 | 379.4 |
| Elastamine ® HT1100 | 328 | 328 | 328 | 328 | 410 | 410 | 410 | 410 |
| NA281 - Antioxidant | 0.82 | 0.82 | 0.82 | 0.82 | 0.82 | 0.82 | 0.82 | 0.82 |
| 1076 | | | | | | | | |
| NA047 (100% solids) | 0.82 | 0.82 | 0.82 | 0.82 | 0.82 | 0.82 | 0.82 | 0.82 |

The thermal properties, melting point (Tm) and crystallization temperature (Tc) and molecular weight of these examples are reported in Table 2.

TABLE 2

| | |
|---|---|
| Molecular Weight | Thermal |

| Example | Mn | Mw | PDI | Tm | Tc |
|---|---|---|---|---|---|
| 1a | 14,776 | 29,878 | 2.02 | 196 | 129.3 |
| 1b | 14,222 | 28,878 | 2.03 | 222 | 163.8 |
| 1c | 20,827 | 52,648 | 2.53 | 213 | 129.2 |
| 1c* | 18,895 | 59,001 | 3.12 | 219 | 128.4 |
| 1d | 10,516 | 25,032 | 2.38 | 230 | 180.5 |
| 1e | 13,797 | 31,838 | 2.49 | 190 | 115.9 |
| 1f | 13,318 | 31,838 | 2.39 | 219 | 154.6 |
| 1g | 14,605 | 37,668 | 2.58 | 208 | 132.4 |
| 1h | 9,185 | 17,730 | 1.93 | 230 | 174.9 |

*Example 1c was repeated with a reduction in the processing time.

For injection molding the molecular weight of Examples 1b, 1e, 1f, and 1g is particular suited. While for monofilament extrusion applications Example 1c is acceptable.

### Example 2

The following polyamide compositions were prepared: a PA66 control (Comp. Ex. A); an impact modified (IM) control (Comp. Ex. B), which is a PA66 feedstock that is compounded with Fusabond™ 493, a maleated polyethylene, and common lubricants; Terpolymer A (Ex. 2A-2D), which comprised 45% polyethylene oxide diamine having a molecular weight of 1700 g/mol in a 55% PA66/PA6 copolymer; and Terpolymer B (Ex. 3), which comprised 45% polytetramethylether diamine having a molecular weight of 1100 g/mol in a 55% PA66/PA610 copolymer.

Terpolymers A and B were blended with a PA66 homopolymer at various amounts (80%-93.5% PA 66 homopolymer), as shown below.

The compositions were then formed into cable ties, as described above, and tested for the following properties: cable tie installation performance at −40° C., loop strength, and flammability. The results are produced in Table 3, below.

TABLE 3

| | | Loop | Loop | | | | |
|---|---|---|---|---|---|---|---|
| | Installation test | strength | strength | | | | |
| | @ −40° C., | @ 23° C. - | @ 23° C. - | | | | |
| | 20% RH (% | DAM (lbf) - | DAM (lbf)- | Flammability | Flammability | Flammability | Flammability |
| Sample | failure) | Avg | SD | @ 0.4 mm | @ 0.75 mm | @ 1.5 mm | @ 3 mm |
| Comp. Ex. 1 | 22.4 | 98.28 | 2.84 | V-2 | V-2 | V-2 | V-2 |
| Comp. Ex. 2 | 0.0 | 48.84 | 3.61 | HB | HB | HB | HB |
| Ex. 2A/PA66 20/80 | 20.0 | 74.09 | 4.21 | V-2 | V-2 | HB | HB |
| Ex. 2B/PA66 15/85 | 7.2 | 89.99 | 4.43 | V-2 | V-2 | V-2 | HB |
| Ex. 2C/PA66 10/90 | 4.8 | 96.12 | 7.97 | V-2 | V-2 | V-2 | V-2 |
| Ex. 2D/PA66 6.5/93.5 | 24.3 | 96.65 | 1.57 | V-2 | V-2 | V-2 | V-2 |
| Ex. 3/PA66 10/90 | 17.5 | 93.5 | 1.83 | V-2 | V-2 | V-2 | HB |

As seen from Table 3, Examples 2 and 3 demonstrated improved flammability at one or more of the flammability tests at 0.4 mm, 0.75 mm, 1.5 mm, and 3 mm, compared to both the PA66 control and the IM control. Examples 2C and 2D demonstrated improved flammability at all four thicknesses.

Additionally, and unexpectedly, Examples 2 and 3 demonstrated an improved failure rate for cable tie installation performance at cold temperatures. One hundred ten (110) ties from each formulation were installed using the procedure described above and observed for breakage during installation, which was then used to calculate the percent failure. In certain instances, the inventive examples showed failure rates under 10% and under 5%.

Additional performance comparisons can be readily gleaned from Table 2.

The same compositions disclosed in Table 3 were also measured for injection molding properties, specifically injection pressure and cycle time. The results are shown in Table 4, below.

TABLE 4

| | Barrel temp | Injection pressure | Cycle time |
|---|---|---|---|
| Sample | (° C.) | (psi) | (s) |
| Comp. Ex. 1 | 330 | 21800 | 12 |
| Comp. Ex. 2 | 330 | 22900 | 12 |
| Ex. 2A/PA66 20/80 | 320 | 18800 | 10 |
| Ex. 2B/PA66 15/85 | 320 | 19300 | 10 |
| Ex. 2C/PA66 10/90 | 320 | 19800 | 10 |
| Ex. 2D/PA66 6.5/93.5 | 320 | 20800 | 10 |
| Ex. 3/PA66 10/90 | 320 | 19800 | 10 |

As can be seen in Table 4, Examples 2 and 3 demonstrated a ˜10-15% reduction in average molding cycle time compared to the neat (control) and impact modified grades for injection molding. Examples 2 and 3 also demonstrated a ˜10-20% reduction in injection pressure compared to neat grade for injection molding. These two injection molding results show that the polyamide compositions of the invention can be processed at lower temperatures compared to neat and impact modified grades, and will have better molecular weight retention, which will further improve performance properties, such as strength and toughness.

### Embodiments

The following embodiments are contemplated. All combinations of features and embodiments are contemplated.

Embodiment 1: A polyamide composition comprising: a base polyamide, and an elastomer concentrate comprising: (a) 20-80 wt % of an elastomeric aliphatic polyether having a molecular weight ranging from 400-4000 g/mol; and (b) 80-20 wt % of a concentrate polyamide.

Embodiment 2: An embodiment of embodiment [0007], wherein the elastomeric aliphatic polyether comprises a compound of the formula:

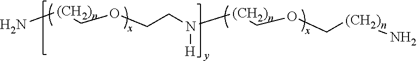

wherein: each n ranges from 1-5; each x ranges from 1-50; and y ranges from 0-2.

Embodiment 3: An embodiment of embodiment 1, wherein the elastomeric aliphatic polyether is a polytetramethylether diamine.

Embodiment 4: An embodiment of embodiment 1, wherein the elastomeric aliphatic polyether is a polyethylene oxide diamine.

Embodiment 5: An embodiment of embodiment 2, wherein n is 3 and the elastomeric aliphatic polyether has a molecular weight of 500-1500 g/mol.

Embodiment 6: An embodiment of embodiment 2, wherein n is 1 and the elastomeric aliphatic polyether has a molecular weight of 1500-2500 g/mol.

Embodiment 7: An embodiment of embodiment 2, wherein y is 0 and the elastomeric aliphatic polyether is a diamine.

Embodiment 8: An embodiment of embodiment 1, wherein the concentrate polyamide comprises PA6,6; PA6; PA610; PA611, PA612; PA10; PA11; or PA12; or combinations thereof.

Embodiment 9: An embodiment of embodiment 1, wherein the elastomer concentrate comprises a copolymer/terpolymer comprising elastomer repeat units and polyamide repeat units comprising PA6,6; PA6; PA610; PA611, PA612; PA10; PA11; or PA12; or combinations thereof.

Embodiment 10: An embodiment of embodiment 1, wherein the elastomer concentrate comprises a terpolymer of PA6,6, PA6, and the elastomeric aliphatic polyether.

Embodiment 11: An embodiment of embodiment 1, wherein the elastomer concentrate comprises a terpolymer of PA6,6, PA6,10, and the elastomeric aliphatic polyether.

Embodiment 12: An embodiment of embodiment 1, wherein the polyamide composition comprises 5-20 wt % of the elastomer concentrate and 80-95 wt % of the base polyamide.

Embodiment 13: An embodiment of embodiment 1, wherein the base polyamide comprises a PA6,6 homopolymer.

Embodiment 14: An embodiment of embodiment 1, further comprising one or more lubricants.

Embodiment 15: An embodiment of embodiment 14, wherein the lubricant is selected from the group consisting of ethylene bis(stearamdie) (EBS), stearyl erucamide, montan waxes, polyethylene waxes, polypropylene waxes, and combinations thereof.

Embodiment 16: An embodiment of embodiment 1, further comprising one or more heat stabilizers.

Embodiment 17: An embodiment of embodiment 1, further comprising colorants, carbon black, and/or nigrosine.

Embodiment 18: An embodiment of embodiment 1, further comprising one or more nucleating agents.

Embodiment 19: An embodiment of embodiment 18, wherein the nucleating agents are selected from the group consisting of calcium fluoride, calcium carbonate, talc, PA 2,2, and combinations thereof.

Embodiment 20: An article for use in cold-temperature applications, wherein the article is formed from the polyamide composition of embodiment 1, wherein the article is used for fasteners, circuit breakers, terminal blocks, connectors, automotive parts, furniture parts, appliance parts, cable ties, sports equipment, gun stocks, window thermal breaks, aerosol valves, food film packaging, automotive/vehicle parts, textiles, industrial fibers, carpeting, or electrical/electronic parts.

Embodiment 21: An embodiment of embodiment 20, wherein the article is a cable tie.

Embodiment 22: An embodiment of embodiment 20, wherein the article demonstrates a tensile strength greater than 60 MPa, and a flame rating of V-2 or higher.

Embodiment 23: An embodiment of embodiment 21, wherein the article demonstrates a cold-weather cable-tie-installation-performance fail rate of less than 10%.

Embodiment 24: A process for improving cold-temperature performance in a polyamide composition, comprising the step of adding to a base polymer an elastomer concentrate comprising an elastomer concentrate comprising: (a)20-80 wt % of an elastomeric aliphatic polyether having a molecular weight ranging from 400-4000 g/mol; and (b) 80-20 wt % of a concentrate polyamide, to produce a modified polyamide composition having improved cold-temperature performance.

Embodiment 25: An embodiment of embodiment 24, wherein the polyamide composition is a cable tie, and the improved cold-temperature performance demonstrated by a cold-weather cable-tie-installation-performance fail rate of less than 10%.

Embodiment 26: An embodiment of embodiment 24, wherein the polyamide composition has a tensile strength of 60 MPa or greater, and a flame rating of V-2 or higher.

Embodiment 27: An elastomer concentrate, comprising (a) 20-80 wt % of an elastomeric aliphatic polyether having a molecular weight ranging from 400-4000 g/mol; and (b) 80-20 wt % of a concentrate polyamide.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit.

We claim:

1. A polyamide composition comprising:
a base polyamide, and
an elastomer concentrate comprising:
a. 20-80 wt % of an elastomeric aliphatic polyether having a molecular weight ranging from 400-4000 g/mol; and
b. 80-20 wt % of a concentrate polyamide.

2. The polyamide composition of claim 1, wherein the elastomeric aliphatic polyether comprises a compound of the formula: 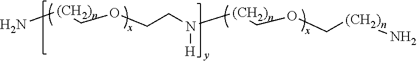
wherein:
each n ranges from 1-5;
each x ranges from 1-50; and
y ranges from 0-2.

3. The polyamide composition of claim 1, wherein the elastomeric aliphatic polyether is a polytetramethylether diamine.

4. The polyamide composition of claim 1, wherein the elastomeric aliphatic polyether is a polyethylene oxide diamine.

5. The polyamide composition of claim 2, wherein n is 3 and the elastomeric aliphatic polyether has a molecular weight of 500-1500 g/mol.

6. The polyamide composition of claim 2, wherein n is 1 and the elastomeric aliphatic polyether has a molecular weight of 1500-2500 g/mol.

7. The polyamide composition of claim 2, wherein y is 0 and the elastomeric aliphatic polyether is a diamine.

8. The polyamide composition of claim 1, wherein the concentrate polyamide comprises PA6,6; PA6; PA610; PA611, PA612; PA10; PA11; or PA12; or combinations thereof.

9. The polyamide composition of claim 1, wherein the elastomer concentrate comprises a copolymer/terpolymer comprising elastomer repeat units and polyamide repeat units comprising PA6,6; PA6; PA610; PA611, PA612; PA10; PA11; or PA12; or combinations thereof.

10. The polyamide composition of claim 4, wherein the elastomer concentrate comprises a terpolymer of PA6,6, PA6, and the elastomeric aliphatic polyether.

11. The polyamide composition of claim 3, wherein the elastomer concentrate comprises a terpolymer of PA6,6, PA6,10, and the elastomeric aliphatic polyether.

12. The polyamide composition of claim 1, wherein the polyamide composition comprises 5-20 wt % of the elastomer concentrate and 80-95 wt % of the base polyamide.

13. The polyamide composition of claim 1, wherein the base polyamide comprises a PA6,6 homopolymer.

14. The polyamide composition of claim 1, further comprising one or more lubricants.

15. The polyamide composition of claim 14, wherein the lubricant is selected from the group consisting of ethylene bis(stearamdie) (EBS), stearyl erucamide, montan waxes, polyethylene waxes, polypropylene waxes, and combinations thereof.

16. The polyamide composition of claim 1, further comprising one or more heat stabilizers.

17. The polyamide composition of claim 1, further comprising colorants, carbon black, and/or nigrosine.

18. The polyamide composition of claim 1, further comprising one or more nucleating agents.

19. The polyamide composition of claim 18, wherein the nucleating agents are selected from the group consisting of calcium fluoride, calcium carbonate, talc, PA 2,2, and combinations thereof.

20. An article for use in cold-temperature applications, wherein the article is formed from the polyamide composition of claim 1, wherein the article is used for fasteners, circuit breakers, terminal blocks, connectors, automotive parts, furniture parts, appliance parts, cable ties, sports equipment, gun stocks, window thermal breaks, aerosol valves, food film packaging, automotive/vehicle parts, textiles, industrial fibers, carpeting, or electrical/electronic parts.

21. The article of claim 20, wherein the article is a cable tie.

22. The article of claim 20, wherein the article demonstrates a tensile strength greater than 60 MPa, and a flame rating of V-2 or higher.

23. The article of claim 20, wherein the article demonstrates a cold-weather cable-tie-installation-performance fail rate of less than 10%.

24. A process for improving cold-temperature performance in a polyamide composition, comprising the step of adding to a base polymer an elastomer concentrate comprising:
an elastomer concentrate comprising:
a. 20-80 wt % of an elastomeric aliphatic polyether having a molecular weight ranging from 400-4000 g/mol; and
b. 80-20 wt % of a concentrate polyamide,
to produce a modified polyamide composition having improved cold-temperature performance.

25. The process of claim 24, wherein the polyamide composition is a cable tie, and the improved cold-temperature performance demonstrated by a cold-weather cable-tie-installation-performance fail rate of less than 10%.

26. The process of claim 24, wherein the polyamide composition has a tensile strength of 60 MPa or greater, and a flame rating of V-2 or higher.
